(19) United States
(12) Patent Application Publication
(10) Pub. No.: US 2005/0046132 A1
(43) Pub. Date: Mar. 3, 2005

(54) Roofing debris collection cart and method of collecting such debris

(76) Inventor: Bryan C. Dulsky, Royal Oak, MI (US)

Correspondence Address: HARNESS, DICKEY & PIERCE, P.L.C., P.O. BOX 828, BLOOMFIELD HILLS, MI, 48303, US

(21) Appl. No.: 10/647,404

(22) Filed: Aug. 25, 2003

(51) Int. Cl. B62B 1/00; B62B 5/00

(52) U.S. Cl. 280/47.34; 280/79.2

(57) ABSTRACT

A roof debris collection cart for collecting debris dropped from a roof during repair and maintenance work on the roof, is formed of an inverted, truncated pyramid shaped container mounted upon a frame having large support wheels. A number of such carts may be aligned end-to-end adjacent an external wall of a house. Large flat panels arranged between the house wall and containers, may be leaned against the house walls at an angle corresponding to the angle of the adjacent walls of the containers. The panels are arranged substantially co-planar with their adjacent container walls. Thus, debris, such as shingles, bricks and the like, that are dropped down from the roof upon the panels, slide down the panels and into their respective containers. The support wheels are large enough to hold the containers at a sufficient height above the ground to minimize contact with plantings which are located near the house wall.

### BACKGROUND OF THE INVENTION

This invention relates to a moveable cart which is particularly useful for receiving and moving away debris that is dropped from the roof of a house or other building during roofing repairs or replacement.

During the repairs or replacements of building roofs, the roofer tradesmen typically remove unwanted shingles, bricks or the like roofing materials from the existing roofs. They discard such materials by throwing them from the roof to the ground. The materials which are discarded, and which are referred to as “debris,” form an unsightly deposit along the sides of a house. In addition, collecting that debris which typically is scattered on the ground near the walls of the house, takes considerable time and effort. The debris often gets in the way of the tradesmen during their work, such as blocking the lifting of replacement material to the roof. Thus, the tradesmen may have to stop their repair work, when necessary to remove piles of debris which block their movements. Moreover, where there are plantings, such as bushes or flower beds along side the walls of a house, the falling debris may damage or destroy such plantings. In some cases, that may require replacement of plants after the roof work is completed.

It is desirable to have some simplified way and equipment to receive and collect the falling debris which is thrown or drops from a roof during repair or replacement work to minimize the time and effort required for collecting such debris and for minimizing damaging plantings located near the house walls. Thus, this invention is concerned with providing a simplified, inexpensive, collection cart which may be used either singly or with a group of aligned carts, that can be easily positioned to collect debris dropping from roofs and which can be easily handled by one person so that the labor of collecting fallen debris is minimized, the number of times required to remove piles of debris which interfere with the replacement work is reduced, and damage to plantings is minimized.

In the past, the use of wheel barrows or other containers have been used but these require considerable labor to collect the debris that piles upon the ground and to place such debris into a wheel barrow or container for removal. Thus, it would be desirable to have a system which substantially reduces the need to manually pick up fallen debris from the ground for removal and to protect the surrounding plantings from being excessively damaged.

### SUMMARY OF THE INVENTION

This invention relates to a system, including a cart which is formed to fit adjacent the wall of a dwelling house for receiving debris thrown or dropped off the roof during repair or reconstruction of the roof by a roofer tradesman. Preferably a series of such carts are aligned, end to end, to provide an elongated receptacle along the side of the house for receiving falling debris. Thus, the aligned carts divide the combined receptacle into a number of parts. Each part, that is each cart, can be easily moved by a single workman to a collection vehicle or large collection container for discarding the debris and preventing the debris from scattering around the building.

This invention contemplates the utilization of large panels, as for example, large plywood sheets, which can be positioned along the wall of a house or other building at an angle to straddle plantings located near the house wall. The panels are positioned between the carts and the wall so as to direct falling debris into one or more carts, thereby collecting randomly dropping debris and preventing the debris from scattering upon the ground around the house. Alternatively the lower edges of the panels may be attached to an edge of a cart to support the panels and raise them above the ground.

The invention contemplates utilizing a simplified cart which preferably is in the form of a box-like container, shaped like an inverted, truncated pyramid. The shape provides sloping inner and outer walls and end walls with a small base and an open large top. The container is mounted upon a suitable support frame, such as a generally rectangularly shaped framework of metal strips upon which the container base is secured by mechanical fasteners, such as rivets or bolts or by welding. Relatively large wheels are mounted upon the bottom of the frame for supporting the cart and enabling a single workman to move the cart.

It is contemplated to align the large panels or sheets, end-to-end, and to lean them against the wall of a house at an angle that corresponds to the angle of the inner wall of the container. Thus, the panels are arranged next to, and approximately parallel to, the adjacent walls of the container portions of the carts. Alternatively, the lower edges of the panels may be supported upon the adjacent walls of the carts. Hence, debris which is randomly dropped or thrown from the roof of a house during work on the roof, will drop down upon an angled panel and will slide down or be directed downwardly into a cart container. The relatively large wheels of the carts reduce or limit the amount of contact that the carts make with plantings that may be located along the side of the building to minimize damage to such plantings.

By utilizing a series of such carts, arranged end-to-end, to form an elongated receptacle alongside the wall of the house, the “receptacle” that is formed by the series is separated into manageable parts for transporting the collected debris. Thus, debris falling anywhere along the wall where the carts are located will drop into this elongated “receptacle” whose constituent carts can be manually rolled to a suitable central dumping location, such as a trash truck or large trash container of the type that is conventionally used at construction sites.

An object of this invention is to provide a method or system by which debris tumbling or dropped from the roof of a house will not scatter, but rather will be easily collected by being directed into relatively small size containers that can be easily moved by a single individual for moving and dumping the debris that is collected.

A further object of this invention is to provide a system by which debris falling from the roof of a building during construction on the roof will not scatter or damage plantings and which by being collected in a series of moveable carts, minimizes the amount of labor and effort required for disposing of the debris.

Yet another object of this invention is to provide an inexpensive cart of simplified construction, which can be used individually or in a series of such carts arranged end-to-end for providing an elongated receptacle for receiving falling debris. In cooperation with suitable panels that direct the dropping debris into the carts, the cart-panel assembly will protect the building wall and any adjacent plantings from falling debris.

### BRIEF DESCRIPTION OF THE DRAWINGS

FIG. 1 is a top plan view of the cart, illustrating a preferred shape of the cart.

FIG. 2 is a cross-sectional, side view taken in the direction of arrows 2-2 of FIG. 1.

FIG. 3 is a cross-sectional, front view of the cart taken in the direction of arrows 3-3 of FIG. 1.

FIG. 4 is a bottom, plan view of the cart.

FIG. 5 is a disassembled view of the support frame and wheel mounting parts.

FIG. 6 schematically illustrates an end view of a cart positioned near a building wall and a panel propped against the wall, next to the cart for receiving dropped or falling debris from the roof of the building.

FIG. 7 is a schematic illustration, similar to FIG. 6, but showing the panel lower edge supported upon the upper edge of the cart wall that is nearest to the building.

FIG. 8 illustrates a series of carts arranged end-to-end to form a continuous, elongated receptacle along the side of the wall of the house, with a series of panels arranged between the carts and the wall of the house.

FIG. 9 is an enlarged, fragmentary view of the socket formed on the upper edge of the cart wall for loosely supporting the panel lower edge.

FIG. 10 schematically shows the cart tipped for dumping debris.

FIG. 11 illustrates, in enlarged scale, the attachment of the rear wheels to the frame of the cart.

### DETAILED DESCRIPTION

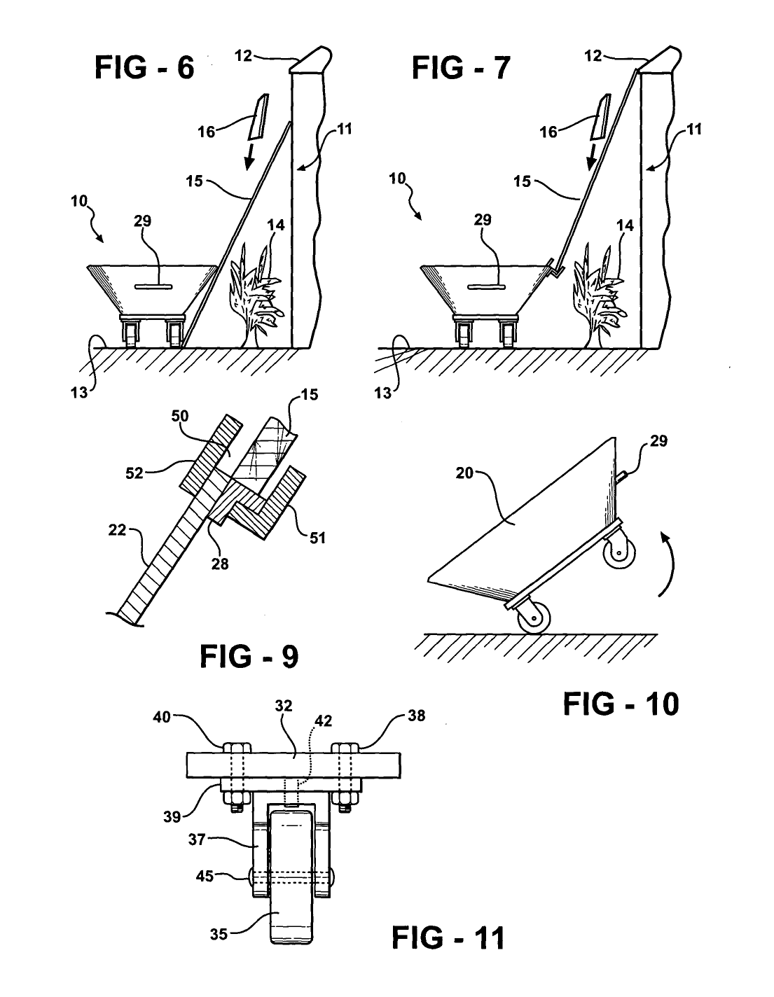

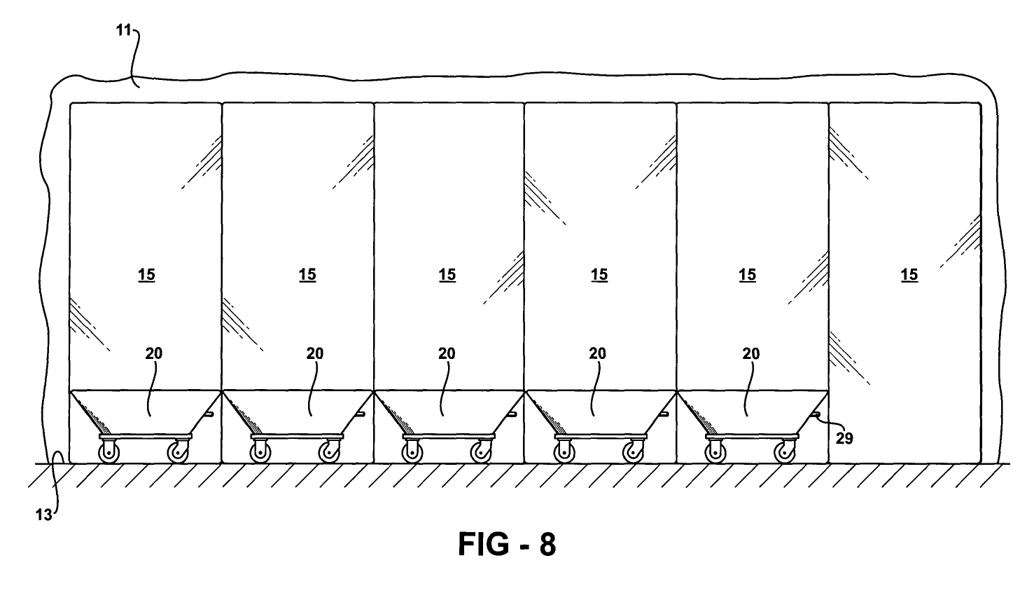

FIGS. 6 and 7 schematically illustrate a debris collection cart 10 arranged alongside of the wall 11 of a house, which is schematically illustrated. The roof 12 of the house is shown schematically. The cart is arranged parallel to, and spaced a short distance from, the house wall 11 and rests upon the ground 13. Plantings 14, such as flowers or bushes, are schematically illustrated.

A large plywood sheet 15 is propped against the wall of the house. The sheet or panel may be formed of any commercially available material and is preferably large enough to extend a considerable distance above the cart and to be arranged at an angle relative to the wall of the house so that the panel straddles the plantings 14. Such sheets typically are commercially available in 4 ft.×8 ft. sizes with thicknesses of about ¼ to 1/2 inches. However, the sheet sizes and thicknesses may vary.

During work on the roof, roofers usually remove and discard pieces of shingles, bricks, and other such materials that are found on roofs. Normally the roofers either throw or drop those items off the roof to fall to the ground. FIGS. 6 and 7 schematically show the debris 16 which, for example, comprises discarded shingles or the like. The debris, in falling from the roof, tends to either slide or bounce down the surface of the panel 15 and is directed into the cart.

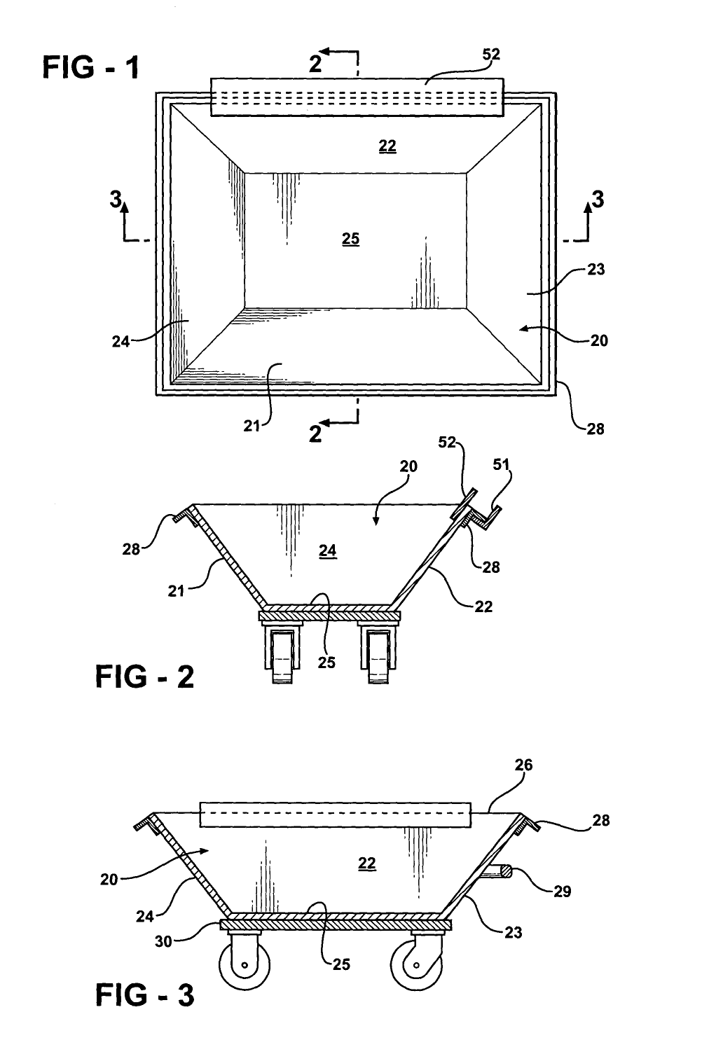

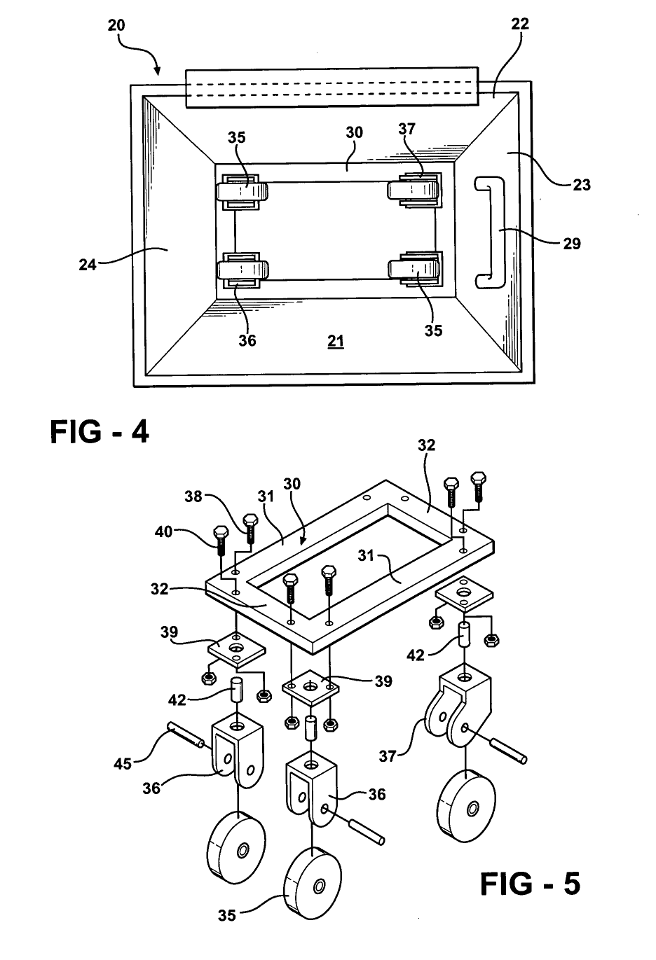

As illustrated in FIGS. 1-5, the cart comprises a container or receptacle 20 which preferably is shaped like an inverted truncated pyramid. That is, the container is formed with a front or outer wall 21, a rear or inner wall 22 and opposite end walls 23 and 24 that are joined together, such as by welding bolts or one-piece construction. Similarly the walls are jointed to a floor or base 25. The container has an open top 26. The open top corresponds to the larger base of a pyramid and the floor or base 25 corresponds to the smaller base of an inverted truncated pyramid.

The container may be made of suitable sheet metal, or plastic, which is strong enough to sustain the force of dropping debris. Preferably, an edge bead or flange 28, such as an elongated strip of angle iron is fastened along the upper edges of the walls forming the container. This strengthens the walls and resists the impacts of heavy debris, such as falling bricks.

Handles 29 are secured on the end wall 23. Another handle may be attached on the opposite end wall (not shown). Preferably, the handle is formed of a U-shaped bent metal strip whose legs are secured mechanically to the container end walls, such as by welding or by suitable bolts and nuts or by rivets.

The container rests upon a horizontally arranged support frame 30. The frame may be formed in a rectangular shape out of longitudinal strips 31 connected together by transverse strips 32. The strips may be formed of conventional angle iron. The actual construction of the frame may vary and can be appropriately formed by one skilled in the manufacture of metal objects of this type.

Relatively large wheels 35, for example, wheels that are eight inches in diameter or more, are secured to the bottom of the frame for enabling the cart to be easily moved. Inverted U-shaped yokes 36 are secured to the frame at one end, which forms the forward end, of the cart. Similar inverted U-shaped yokes 37 are secured to the opposite, rear end of the cart. Preferably the forward yokes are fastened by bolts 38 (schematically shown) to plates 39, which in turn are fastened by bolts 40 to the frame. The yokes at the rear end, preferably are secured by a pin 42 or similar rotateable connector for pivotally connecting the rear yokes 37 to the frame so that they may swivel. Thus, the rear wheels can swivel during movement of the cart. The bolts 38 that secure the yokes 36 at the forward end of the cart may hold those yokes against swiveling so that only the rear wheels can swivel. Alternatively, both front and rear wheels can be swivellably attached. The wheels 35 may be connected to the yokes by suitable axles 45.

In operation, the roofer positions a cart near, but spaced a short distance from, the wall of the house. The rear wall 22 of the cart is arranged parallel to the wall. The large wheels 25 of the cart raise the box-like container and frame of the cart above the plantings. In most cases, the cart is spaced high enough, so that it minimally disturbs any plantings that may be located near the wall. For moving the cart, the handle 28 of the cart form a convenient way to manually grasp and move the cart as desired.

The large panels or sheets 15 which may be, for example, formed of standard size plywood panels, or other suitable panel material, are propped against the wall of the house at an angle which corresponds to the angle of the rear wall 22 of the cart. By way of example, approximately a 52 degree angle relative to the horizontal ground or 38 degree angle relative to the vertical wall is preferable for this purpose. The exact angle is not critical, but may be empirically determined by the workmen. By arranging the panel at approximately the same angle as the adjacent wall of the cart, the two may be arranged close enough that they can be arranged in substantial face-to-face contact as shown in FIG. 6. Small variances in distance between the panel surface and the cart wall would not be material because the debris, generally, is likely to be large enough to fall across any small spaces between the cart wall and the panel surface.

As illustrated in FIG. 7, the panel 15 may be arranged with its lower edge loosely fitted within a socket 50 formed on the upper edge of the rear wall 22. The socket, as schematically illustrated in FIG. 9, is formed by attaching an angle strip 51 to the edge bead or strip 28 and attaching a flat strip 52 to the upper portion of wall 22. Because the socket is wider than the thickness of the panel 15, the angle of the panel relative to the wall, can be adjusted a small amount, as desired by the roofing workmen.

While a single cart together with a single panel may be used during repairs on a roof for catching debris thrown or dropped from the roof, preferably a series of substantially identical carts, are arranged end-to-end, as illustrated in FIG. 8, to form a continuous receptacle made of the individual carts. The angularity of the end walls of the carts provide a space between adjacent carts within which space the handles 29 may extend. The angularity of the end walls may vary, but a roughly 52 degree angle relative to the horizontal is preferable for good results.

Where there are a number of carts arranged end-to-end, a number of panels are also arranged edge-to-edge and are leaned against the building wall at an angle, as indicated in FIG. 6. Thus, the workmen may randomly throw or drop debris from the roof knowing that the falling debris will not damage the building wall or windows or the plantings that are covered by the panels. Rather, the debris will be directed into one or another of the carts.

When the carts are sufficiently filled or when the job is completed, a single workman can easily grasp the handles of the carts, and push the carts, one by one, to either a dump area, or to a suitable large debris container for debris or to a trash removal truck or the like. Significantly, the debris is collected in the containers without being dispersed upon the grounds around the house. Collection in the carts materially reduces the amount of labor needed in cleaning up after work on a roof. That materially saves money and time in performing roof repairs or replacements, as well as avoiding the unattractive appearance of scattered debris during the construction work.

The sizes and the angularities of the walls of the containers may vary. By way of example, the length of the front and rear walls of the container may be on the order of about 4 feet, plus or minus some small amount and the width of the container may be on the order of roughly 3 feet in length. The container may be roughly in the order of about 11¼ inches in height. The flat base portion may be roughly 30 inches long and 20 inches in width. And the angle iron edge strip may be about 1/2 inch by 1/2 inch and 1/8 inch thick and made of a suitable metal or plastic. The socket forming strip 51 may be of sufficient height to provide a socket width of roughly ¾ inch, depending upon the thickness of the rear metal wall 22. Hence, a commercial 4 ft. wide by 8 ft. wide plywood panel of about ¼ inch to 1/2 inch thickness can easily fit into the channel 50, and its angle of tilt against the house wall can be adjusted.

The dimensions set forth above are exemplifications of containers that are of a size which could be easily maneuvered about by a single workman and yet can receive a substantial load of debris. However, as can be seen, the sizes of the containers and the overall sizes of the carts may vary, subject to the containers being of a size which permits relatively easy handling of the cart by an individual workman and of a depth and width and elevation above the ground that will have a minimal destructive effect on plantings located near the sides of the house.

Having fully described an operative embodiment of this invention and the method of performing it, it should be understood that this invention may be further developed within the scope of the following claims. Accordingly, it is now claimed:

1. A roofing debris collection cart comprising:
an open top container formed generally in the shape of an inverted, truncated pyramid having its lower, smaller base closed and its upper, larger base open and having end walls joined to inner and outer walls which are sloped, relative to the vertical, at pre-determined angles;
a horizontally arranged support frame located beneath and secured to the smaller base for supporting the container;
and support wheels rotateably connected to, and depending beneath, the frame for engagement with the ground upon which the cart is supported;
and with the angle of the inner wall of the container being substantially the same as an angle selected for leaning a large, flat panel against the wall of a house at a location between the container and the house wall so that the panel is adapted to be arranged close to the container for directing debris dropped down upon the panel into the container.

2. A roofing debris collection cart as defined in claim 1, and including a large, flat panel adapted to be leaned against the surface of a house wall at an acute angle, while resting upon the ground, and for being located between a cart and the house wall, with the angle of the panel and the angle of the inner wall of the cart being substantially the same whereby the panel may be closely adjacent to the inner wall of the cart.

3. A construction as defined in claim 2, and with the slope angle of the cart inner wall being approximately 52 degrees relative to the horizontal.

4. A roof debris collection cart as set forth in claim 1, and including a number of said carts of substantially identical construction, arranged end-to-end for positioning alongside a house wall so that the carts together form an elongated receptacle along the house wall for debris dropped from the roof; and with large, flat, panels arranged closely adjacent to the carts and propped against the house wall at an angle approximately the same as the angularity as the inner walls of the carts.

5. A construction as defined in claim 4, and including handles located on the respective end walls of the carts, with the handles extending away from their respective sloped end walls for a pre-determined distance sufficient to prevent the handles on the adjacent cart end walls from interfering with or contacting the handles on the next adjacent carts.

6. A construction as defined in claim 4, and including a series of large, flat panels, arranged end-to-end, and rested upon the ground and leaned at an angle against the house wall, between the carts and the house wall, and each panel being in substantial face-to-face engagement with their adjacent container walls for directing debris dropped from the roof of the house into the respective containers.

7. A construction as defined in claim 2, and said wheels being of a large enough diameter to support the cart at a substantial height above plantings that may be located near the house wall and with the panel angled sufficiently so that its lower portion is spaced from the house wall so that the panel straddles over plantings located closely adjacent to the house wall.

8. A construction as defined in claim 1 and the inner wall having an upper portion with a channel forming socket on the said upper portion for receiving the lower edge of a panel which is leaned against the house wall.

9. A construction as defined in claim 8 and including a pair of spaced apart elongated strips secured to the upper portion of the inner wall to form the channel therebetween for receiving the lower edge of said panel.

10. A roofing debris collection cart comprising:
a box-like container having an inner and an outer wall connected to end walls which are in turn connected to a closed base, and with the container having an open top;
said inner wall being angled, relative to the vertical, at roughly 52 degrees to the horizontal from the base floor to the open top of the container;
a horizontally arranged support frame secured to and arranged beneath the container base floor;
support wheels rotateably connected to the frame and depending beneath the frame for engagement with the ground upon which the cart is supported;
whereby said cart may be located adjacent a building wall, but spaced therefrom, so that a flat, large panel may be arranged between the cart inner wall and the building wall at an angle approximately the same as the angle of the cart inner wall whereby the cart inner wall and the panel may be arranged closely adjacent to each other and in approximately the same angular plane in order to permit debris dropped from the roof of the building upon the panel to slide down the panel and into the container.

11. A construction as defined in claim 10, and including the opposite end walls of the cart being sloped at a pre-determined angle, inwardly, from the open top to the closed base floor;
and a manually gripable handle mounted upon an end wall;
whereby a number of substantially identical carts may be arranged end-to-end with the upper edges defining the end walls in contact with the adjacent parts of the adjacent carts and with their handles being located in the spaces formed between the adjacent end walls by the angularity of the end walls relative to each other;

12. A method for collecting debris dropped from the roof of a building comprising:
providing an open container having front and rear walls and end walls, with the rear wall being sloped at an acute angle relative to the vertical, and with the container being supported upon wheels for moving the container;
moving the container into a position where its sloped rear wall is spaced a pre-determined distance from a wall of the building;
positioning a large, flat panel on the ground between the container and the building wall, with a panel extending upwardly at an angle that generally corresponds to the angle of the rear wall of the container and with the panel closely arranged adjacent said sloped rear wall of the container;
dropping debris from the building roof downwardly upon the panel so that the debris is guided down the panel and into the container.

13. A method as defined in claim 12, and selecting wheel sizes which elevate the container above the ground a pre-determined distance above plantings on the ground near the house wall, and selecting an angle of the panel so that the lower part of the panel is spaced from the wall and straddles plantings that are arranged between the cart and the building wall.

14. A method as defined in claim 13, and including aligning, in end-to-end relationship, a series of said carts and a series of said panels between the carts and the building wall to form a composite, elongated debris receptacle extending along the wall of the building beneath the roof for receiving debris dropped downwardly from the roof.
